(19) United States
(12) Patent Application Publication
(10) Pub. No.: US 2001/0000546 A1
(43) Pub. Date: May 3, 2001

(54) Particles comprising magnesium chloride, process for their production, and polyolefin particles

(75) Inventor: Claude Brun, Idron (FR)

Correspondence Address: Frederick F. Calvetti, SMITH, GAMBRELL & RUSSELL, LLP, Suite 800, 1850 M Street, N.W., Washington, DC, 20036, US

(73) Assignee: ELF ATOCHEM S.A.

(21) Appl. No.: 09/738,141

(22) Filed: Dec. 18, 2000

Related U.S. Application Data
(63) Continuation of application No. 09/385,434, filed on Aug. 30, 1999, now abandoned.

(30) Foreign Application Priority Data
Jun. 21, 1995 (FR) 95.07397

(51) Int. Cl. C01F 5/30

(52) U.S. Cl. 23/301; 23/304; 423/497; 428/402

(57) ABSTRACT

The present invention relates to a process for the manufacture of particles comprising magnesium chloride, which may serve as a support for a catalytic component for the polymerization of olefins, this process comprising a step of placing in contact between solid particles, an organomagnesium derivative and a chlorinating agent for the organomagnesium derivative. The process affords excellent control over the morphology of the support particles, particles of catalytic component and polymer particles.

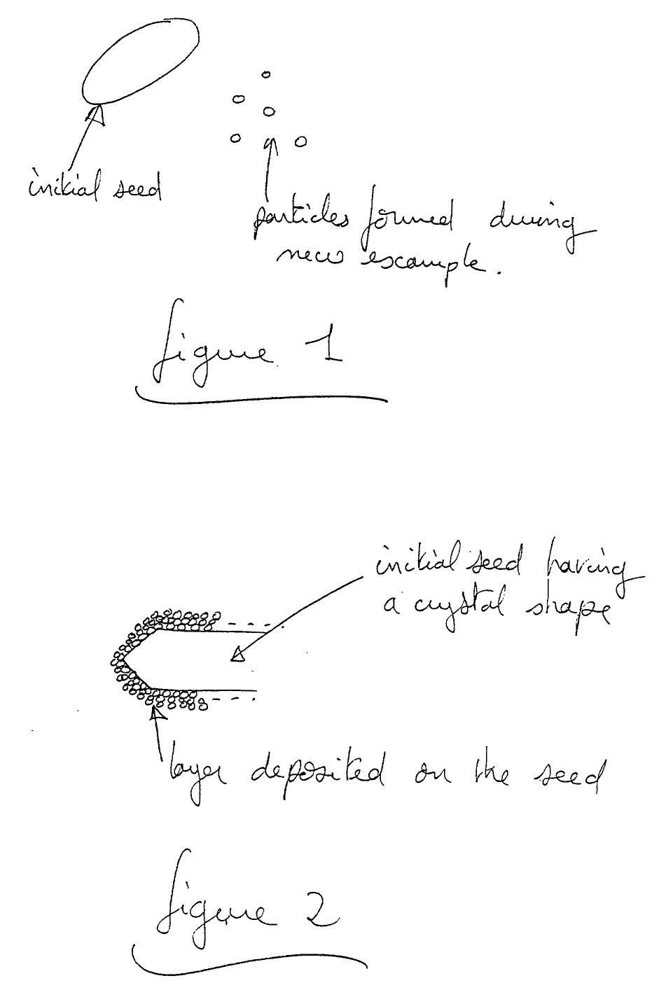

1. The present invention relates to a process for the manufacture of particles comprising magnesium chloride, which may act as a support for a solid catalytic component for the polymerization of olefins.

2. It is known how to produce supports for a solid catalytic component by precipitation of MgCl₂ from an organic solution of an organomagnesium derivative, a chlorinating agent for this organomagnesium derivative and an ether oxide such as diisoamyl ether. In the absence of diisoamyl ether, this process leads to particles of altered morphology, as well as to the presence of unwanted fine particles. Such is also the case when an attempt is made in this process to replace the diisoamyl ether by tetrahydrofuran (THF).

3. Patent application FR 2,529,208 describes such a process using diisoamyl ether, which leads to spherical particles containing diisoamyl ether. When it is desired to use these particles to manufacture a stereoselective solid catalytic component, this ether can conveniently be substituted, in an additional step, with an electron donor such as an aromatic diester, which is capable of imparting the desired stereoselective properties to the catalytic component. Another drawback of these particles, after conversion into solid catalytic component, is that they lead, after polymerization, to spherical polymer particles which are particularly liable to accumulate electrostatic charge, which may be the cause of the formation of agglomerates or blockages inside the industrial plants in which these polymer particles are conveyed. In particular, this problem is encountered in gas-phase polymerization reactors in which the spherical polymer particles form agglomerates on the wall, which agglomerates, on becoming suddenly detached, give rise to perturbations in the hydrodynamic regime of the reactor and obstruct withdrawals. The tendency of the spherical shape of a particle to favour the accumulation of electrostatic charge may also be found in the support particles themselves, as well as in the particles of solid catalytic component manufactured from the said support particles.

4. The present invention relates to a process for the manufacture of particles comprising magnesium chloride, this process comprising a step of placing in contact between:

5. solid particles,

6. an organomagnesium derivative,

7. a chlorinating agent for the organomagnesium derivative.

8. The solid particles may also be referred to as “seeds” in the present application. The particles comprising magnesium chloride which are obtained by the process according to the invention may also be referred to as support particles in the present application.

9. The process according to the invention has, in particular, the following advantages:

10. 1. It is possible to influence the shape of the support particles by the shape of the seed particles. For example, if the seeds have an elongate shape, the support particles will also have an elongate shape. It is thus possible, by means of the process according to the invention, to optimize the shape of the support particles,. of the particles of catalytic component made from the support particles, and of the polymer particles finally synthesized, as a function of the desired physical characteristics such as, for example, the flowability of these particles or their ability not to accumulate electrostatic charge.

11. 2. It is possible to influence the size of the support particles by modifying the size of the seed particles. Thus, by increasing the size of the seed particles, the size of the support particles may be increased.

12. 3. It is possible to influence the size of the support particles by modifying the ratio of the amount of organomagnesium derivative to the amount of support. Thus, by increasing this ratio, the size of the support particles may be increased.

13. 4. It is possible to influence the size distribution of the support particles by acting on the size distribution of the seed particles. The reason for this is that the size distribution of the support particles, particles of the catalytic component derived therefrom and of the polymer particles derived therefrom, measured by SPAN (see below), is substantially similar to the size distribution of the seed particles used. The SPAN is equal to the ratio (D90-D10)/D50 in which D90, D10 and D50 represent the diameter below which 90%, 10% and 50% by weight of the particles are found respectively. Generally, the SPAN of the support does not exceed the SPAN of the seeds by more than 50%, or even 20%, and is even, generally, less than that of the latter.

14. 5. The process according to the invention is particularly advantageous when narrow size distributions of particles (support, solid catalytic component or polymer) are desired, since the size distribution of the support particles is generally narrower than the size distribution of seed particles.

15. 6. It is not necessary to add an ether to the medium in which the placing in contact takes place. When there is no ether in the medium of placing in contact and in the seeds, the support particles contain no ether.

16. 7. If it is desired for the support particles to contain an ether in order, for example, to modify their crystalline organization, it is possible to achieve this by introducing an ether into the medium of placing in contact. This ether may be THF. The presence of THF and the absence of diisoamyl ether during the placing in contact does not produce any degradation of the shape of the particles nor is it reflected in the formation of fines, thereby indicating that control over the morphology of the particles is retained. Moreover, if so desired for any particular reason, it is possible to add diisoamyl ether to the medium of placing in contact.

17. 8. The support particles have a surface which is substantially free of rough edges when they are observed at a magnification of 200 under a scanning electron microscope. This uniform surface relief imparts excellent flowability to these particles. This advantage is obtained even if the starting seeds have rough edges, for example if they have the appearance of crystals. Thus, in order to obtain support particles having good flowability, it is possible to use seed particles having an inferior flowability.

18. 9. The particles of solid catalytic component made from these support particles have a surface which is substantially free of rough edges when they are observed at a magnification of 200 under a scanning electron microscope. This uniform surface relief imparts excellent flowability to these particles.

19. 10. The polymer particles obtained by polymerization or copolymerization in the presence of the particles of solid catalytic component have a surface which is substantially free of rough edges when they are observed at a magnification of 20 under an optical microscope. This uniform surface relief imparts excellent flowability to these particles.

20. The seeds preferably contain less than 90% by weight of carbon.

21. The seeds are preferably based on magnesium chloride, that is to say they contain more than 30% by weight of magnesium chloride. Even more preferably, these seeds contain magnesium chloride in a form which is capable of fixing titanium chloride. In order to know whether a seed based on magnesium chloride is in such a form, the following test may be performed:

22. 10 g of seeds and then 33 cm³ of pure TiCl₄ are introduced into a glass reactor equipped at its bottom with a filter, flushed with 250 cm³ of nitrogen, and equipped with temperature control and a stirring system. This mixture is stirred for one hour at 80° C. and is then filtered. The solid obtained is subsequently washed in the reactor with 50 cm³ of toluene, with stirring for one hour at 80° C. The operation of filtration and then washing with toluene is repeated three times. The solid obtained is filtered off and then dried at 80° C. under a stream of nitrogen at atmospheric pressure for three hours, and then at 100° C. for two hours under a vacuum whose residual nitrogen pressure is 10 Pa. The powdery solid is recovered under an inert atmosphere (argon or nitrogen for example) and its titanium content is analysed.

23. After this treatment, if the seed particles contain more than 0.2% by weight of titanium, these seed particles, before the test, may be considered as being in a form which is capable of fixing titanium chloride. As examples of seeds based on magnesium chloride in a form which is capable of fixing titanium chloride, mention may be made of:

24. the β or δ forms of magnesium chloride or a mixture of these two forms, it being possible for the δ form to be obtained, for example, by grinding commercial anhydrous MgCl₂,

25. complexes of formula (MgCl₂·n solvent) in which “solvent” is a solvent which complexes with MgCl₂ and n represents the number of moles of complexing solvent per mole of MgCl₂, the upper limit of n being that for which the complex is no longer solid. By way of example, the complexing solvent may be tetrahydrofuran (THF) or an alcohol of formula ROH in which R may be a hydrogen group containing from one to six carbon atoms. By way of example, n may range from 1 to 2, the complex (MgCl₂·1.5THF) being an example.

26. solid catalytic components of Ziegler-Natta type based on magnesium, chlorine and titanium. The latter types of seed satisfy the test described above since, although they absorb very little or no titanium during the TiCl₄ treatment step of the test, at the end of the test they contain at least 0.2% titanium, in accordance with that which is expected of a seed based on magnesium chloride in a form capable of fixing titanium chloride.

27. Seeds having very varied particle size distributions may be used.

28. Generally, seeds whose average diameter ranges from 1 to 100 μm, and of which the SPAN ranges from 0.4 to 6, are used. The SPAN of the seeds may be less than 3.

29. The organomagnesium derivative used for the step of placing in contact may be of formula R¹MgR² or may be a complex of formula (R¹MgR²)·×(Al(R³)₃) in which R¹ and R², which may be identical or different, represent alkyl radicals containing from 2 to 12 carbon atoms and R³ represents an alkyl radical containing from 1 to 12 carbon atoms. Organomagnesium derivatives which may be mentioned are n-butylethylmagnesium, n-dibutylmagnesium, n-butyl-n-octylmagnesium, n-butylethylmagnesium, n-butyl(1-methylpropyl)magnesium and (n-butyl)_{1.5}(n-octyl)_{0.5}magnesium.

30. The chlorinating agent must be capable of reacting with the organomagnesium derivative in order at least partially to substitute the alkyl radicals of this derivative with chlorine atoms so as to form Mg—Cl bonds. This chlorinating agent, which may be organic or inorganic, may be chosen from the compounds of formula R⁴Cl in which R⁴ represents a secondary or tertiary alkyl radical containing from 3 to 12 carbon atoms. Chlorinating agents which may be mentioned as examples are tert-butyl chloride, silicon tetrachloride and hydrochloric acid.

31. For the placing in contact, amounts of organomagnesium derivative and of chlorinating agent are generally used such that the Cl/Mg molar ratio ranges from 1 to 10.

32. When it is not desired to chlorinate the organomagnesium derivative fully, a Cl/Mg molar ratio of between 1 and 2 may be chosen, for example. By working in the latter manner, on account of the presence of radicals of type R¹ and/or R² and/or R³ remaining in the support particles, the latter will be substantially reductive with respect to the transition metal compounds used to convert the support into a catalytic component, which may be advantageous depending on the type of catalytic component which one undertakes to prepare.

33. The placing in contact is generally performed in the presence of a solvent which is inert with respect to the various ingredients intended to be placed in contact, that is to say, generally, an apolar aprotic solvent.

34. The solvent is inert if, on the one hand, its presence does not modify the nature of the covalent bonds, neither within the molecules of the ingredients used for the placing in contact nor within the molecules derived from the reaction between the ingredients used for the placing in contact, and, on the other hand, if it does not solubilize the seeds or the support by more than 10% by weight.

35. This solvent may generally be a linear or branched aliphatic hydrocarbon containing from 3 to 12 carbon atoms, such as n-hexane, heptane, decane, isodecane, an alicyclic hydrocarbon containing from 5 to 12 carbon atoms such as cyclohexane or decalin, or an aromatic hydrocarbon containing from 6 to 12 carbon atoms, such as toluene, xylene, benzene or ethylbenzene.

36. Obviously, the solvent must be chosen so as to solubilize the reactants chosen, given their nature and their concentration, according to the operating conditions adopted.

37. The solvent is generally present in a sufficient amount such that, at the end of the preparation of the support particles, they are in suspension.

38. The solvent is generally present in an amount such that, at the end of the preparation of the support particles, the medium of placing in contact contains from 70 to 300 grams of support per liter of liquid.

39. When the seeds are based on MgCl₂, preferably, the molar ratio of the amount of magnesium supplied by the organomagnesium derivative to the amount of magnesium contained in the seeds ranges from 0.01 to 10.

40. Although not essential, it is not excluded for the placing in contact to be performed in the presence of an electron donor such as those mentioned later by way of possible internal electron donor. This is a means of introducing an internal electron donor into the support and into the catalytic component resulting therefrom.

41. The placing in contact may be performed between 10 and 140° C. and preferably between 40 and 110° C. It is not excluded to perform it under pressure if the volatility of certain species in the medium makes this necessary.

42. The reaction between the organomagnesium derivative and the chlorinating agent is generally reflected by the evolution of heat. These two reactants are preferably placed in contact sufficiently slowly for the temperature of the medium to remain within the abovementioned range.

43. The organomagnesium derivative and the chlorinating agent (the seeds already being in the presence of one or other of these reactants) are preferably placed in contact for at least one hour.

44. Preferably, the seeds, the possible inert solvent and the organomagnesium derivative are first placed together, and the chlorinating agent is then added to these constituents.

45. When all of the ingredients have been placed in contact, the operating conditions may be maintained, for example for one hour, so as better to consume the reactants.

46. The placing in contact is preferably performed with stirring. This stirring is moderate enough not to bring about attrition of the particles present.

47. After the placing in contact, the support particles may be isolated by filtration, washed with a hydrocarbon solvent such as hexane or heptane, and then dried, for example at 80° C. for 2 hours, flushing with nitrogen at atmospheric pressure.

48. It is possible to perform the placing in contact in the presence of an organoaluminium derivative. The presence of one of these derivatives in the medium for placing in contact is generally reflected by a reduction in the size of the crystallites within the support and, consequently, by improved polymerization activity. This organoaluminium derivative may be a compound of formula R¹R²R³Al envisaged below as a co-catalyst. This may also be an aluminoxane, that is to say a compound comprising at least one Al—O—Al bonding sequence and free of any Si—O bonding sequence, or an aluminosiloxane, that is to say a compound comprising at least one Al—O—Si bonding sequence.

49. The presence of an aluminoxane during the placing in contact is reflected by the fact that the polymer-or copolymer prepared by polymerization in the presence of a solid catalytic component, which is itself prepared from a support derived from the process according to the invention, has a polydispersity, represented by Mw/Mn, which is larger than if the aluminoxane had not been present during the said placing in contact.

50. The aluminoxane may be one of those envisaged below as a co-catalyst.

51. The aluminoxane may be present during the placing in contact such that the molar ratio of the magnesium supplied by the organomagnesium derivative to the aluminium of the aluminoxane is from 1 to 1000 and preferably from 10 to 200.

52. The presence of an aluminosiloxane during the placing in contact is reflected by the fact that the polymer or copolymer prepared by polymerization in the presence of a solid catalytic component, which is itself prepared from a support derived from the process according to the invention, has a polydispersity, represented by Mw/Mn, which is lower than if the aluminosiloxane had not been present during the said placing in contact. The aluminosiloxane may, for example, be of formula R¹R²Al—O—SiR³R⁴R⁵ in which R¹, R², R^{3,} R⁴ and R⁵, which may be identical or different, represent an alkyl radical containing from 1 to 12 carbon atoms, and better still from 1 to 6 carbon atoms, or alternatively hydrogen, preferably for not more than three of these radicals, or alternatively chlorine, preferably for not more than three of these radicals.

53. The aluminosiloxane may be present during the placing in contact such that the molar ratio of the magnesium supplied by the organomagnesium derivative to the amount of Al—O—Si bonding sequence is from 1 to 1000 and preferably from 10 to 200.

54. The support particles may contain no ether of formula R^{a}—O—R^{b}, in which R^{a} and R^{b} are alkyl radicals, if none of these ethers has been introduced during the process for their manufacture and, in particular, neither into the seed particles nor into the medium of placing in contact.

55. Moreover, these particles may contain no cyclic ether, such as tetrahydrofuran or dioxane, if none of these ethers has been introduced during the process for their manufacture and, in particular, neither into the seed particles nor into the medium of placing in contact.

56. These particles may contain aluminium atoms, generally up to 5% by weight, if an organoaluminium derivative has been added during the placing in contact or if the organomagnesium derivative itself contains aluminium. If an aluminosiloxane has been added during the placing in contact, the support particles may contain silicon, for example up to 5% by weight.

57. These particles may have a very narrow particle size distribution, the SPAN of which may be less than 2.5, or even less than 1.

58. The SPAN of the support particles may generally be less than 2.5 if the SPAN of the seeds is less than 3.

59. The SPAN of the support particles may generally be less than 1 if the SPAN of the seeds is less than 1.3.

60. In the following text, the expression large diameter of a particle is understood to refer to the distance between the two furthest points on this particle. The expression small diameter of a particle is understood to refer to the distance between the two furthest points on this particle in a plane perpendicular to the large diameter. The average ratios of the particle diameters are determined by calculating the average of the ratios of the large diameter to the small diameter of the particles after observation under an electronic or optical microscope (according to their size) of a statistically sufficient number of particles.

61. The process according to the invention makes it possible to obtain a set of particles comprising MgCl₂. These particles may serve as a support for a catalytic component for the polymerization of olefins. These particles may be referred to hereinafter as support particles.

62. In the following text, Ds and ds respectively represent the large and small diameters of the support particles and Dg and dg respectively represent the large and small diameters of the seed particles. If the average ratio (Dg/dg)ₘ is increased, the average ratio (Ds/ds)ₘ increases. In another aspect, if the ratio of the amount of organomagnesium derivative to the amount of seeds is increased, the ratio (Ds/ds)ₘ tends to decrease. By routine tests, a person skilled in the art can find, given the ratio (Ds/ds)ₘ which he desires to obtain and the ratio of the amount of organomagnesium derivative to the amount of seeds which he desires to use, a suitable average ratio (Dg/dg)ₘ. Thus, an average ratio (Ds/ds)ₘ>1.3 can generally be obtained if the seeds are such that the ratio (Dg/dg)ₘ>1.4. Obviously, in such an assembly, at least one particle has a ratio of its large diameter to its small diameter of greater than 1.3. Similarly, a ratio (Ds/ds)ₘ>1.5 can generally be obtained if the seeds are such that the ratio (Dg/dg)ₘ>1.6. Obviously, in such an assembly, at least one particle has a ratio of its large diameter to its small diameter of greater than 1.5. Similarly, a ratio (Ds/ds)ₘ>2 can generally be obtained if the seeds are such that the ratio (Dg/dg)ₘ>2.1. Obviously, in such an assembly, at least one particle has a ratio of its large diameter to its small diameter of greater than 2. Similarly, a ratio (Ds/ds)ₘ>3 can generally be obtained if the seeds are such that the ratio (Dg/dg)ₘ>3.1. Obviously, in such an assembly, at least one particle has a ratio of its large diameter to its small diameter of greater than 3.

63. Moreover, the support particles may substantially possess an axis of revolution containing their large diameter. This is the case, in particular, when the seeds used to produce the support are in the polyhedron form which substantially possesses two planes of symmetry which are substantially perpendicular to each other.

64. These polyhedra may be substantially regular and have six or eight faces, the symmetrically opposite paired faces of which are substantially parallel and two large elongated faces of which forming the top face and the-bottom face of a polyhedron, such that in each the largest diagonal (D) is greater than the smallest distance (d) separating two opposite sides, are substantially perpendicularly surrounded by the other substantially rectangular faces forming the sides of the said polyhedron, the length of the shortest side (e) of each of the said substantially rectangular faces being shorter than the shortest distance (d) separating the two opposite sides of the large elongated faces. Such particles may be made of MgCl₂·1.5THF, such as those whose preparation is described in Example 1 of U.S. Pat. No. 3,212,132.

65. These polyhedra may be substantially regular and possess from 10 to 18 faces as an even number, the symmetrically opposite paired faces of which are substantially parallel. Such particles may be made of MgCl₂·1.5THF, such as those whose preparation is described in Example 1 of the patent application whose publication number is EP 0,370,267 A1.

66. A solid catalytic component for the polymerization of olefins may be obtained by combination of a transition metal compound to the support particles. This transition metal may be titanium, zirconium, hafnium, chromium, vanadium or any other metal capable, under suitable conditions, of catalysing the polymerization of olefins. For example, a solid catalytic component for the polymerization of olefins may be obtained by combination of the support, a titanium compound, chlorine, optionally an aluminium compound, optionally an electron acceptor or donor and any other compound which can be used in solid components of Ziegler-Natta type. The particles of catalytic component generally have, when Dc and dc respectively represent their large and small diameters, an average ratio (Dc/dc)ₘ which is substantially equal to (Ds/ds)ₘ of the support used to produce them. Thus, by the process according to the invention, it is possible to prepare sets of component particles whose (Dc/dc)ₘ is greater than 1.3, or even 1.5, or even 2 or even 3. Obviously, in such sets, at least one particle has a ratio of its large diameter to its small diameter which is respectively greater than 1.3, 1.5, 2, 3. Furthermore, the morphology of the component particles is substantially identical to that of the support particles used to produce them. The component particles may thus substantially have an axis of revolution containing their large diameter if the support particles used to produce them substantially have an axis of revolution containing their large diameter.

67. The titanium compound may be chosen from chlorotitanium compounds of formula Ti-(OR)ₓCl₄₋ₓ in which R represents an aliphatic or aromatic hydrocarbon radical containing from one to fourteen carbon atoms, or represents COR¹ with R¹ representing an aliphatic or aromatic hydrocarbon radical containing from one to fourteen carbon atoms and x represents an integer ranging from 0 to 3.

68. The chlorine present in the solid catalytic component may originate directly from the titanium halide. It may also originate from an independent chlorinating agent such as hydrochloric acid, silicon tetrachloride or an organic halide such as butyl chloride.

69. The electron donor or acceptor is a liquid or solid organic compound known to enter into the composition of these catalytic components. The electron donor may be a mono- or polyfunctional compound advantageously chosen from aliphatic or aromatic carboxylic acids and their alkyl esters, aliphatic or cyclic ethers, ketones, vinyl esters, acrylic derivatives, in particular alkyl acrylates or alkyl methacrylates and silanes such as aromatic, alicyclic or aliphatic alkoxysilanes. Compounds such as methyl para-toluates, ethylbenzoate, ethyl acetate, butyl acetate, ethyl ether, ethyl para-anisate, dibutyl phthalate, dioctyl phthalate, diisobutyl phthalate, tetrahydrofuran, dioxane, acetone, methyl isobutyl ketone, vinyl acetate, methyl methacrylate, phenyltriethoxysilane, cyclohexylmethyldimethoxysilane and dicyclopentyldimethoxysilane are suitable in particular as electron donors. The electron donor may also be one of those mentioned in patent application EP 0,361,493. The electron acceptor is a Lewis acid, preferably chosen from aluminium chloride, boron trifluoride, chloranil or alternatively alkylaluminiums, haloalkylaluminiums and alkylmagnesiums.

70. Polymers may be obtained by polymerization of at least one olefin in the presence of the catalytic component according to the invention by suspension, solution, gas-phase or bulk processes. In the present application, the term polymer is considered to cover the terms copolymers and prepolymer.

71. If Dp and dp respectively represent their large and small diameters, the polymer particles generally have an average ratio (Dp/dp)ₘ which is substantially equal to (Dc/dc)ₘ of the catalytic component used to produce them. Thus, by the process according to the invention, it is possible to prepare sets of polymer particles whose (Dp/dp)ₘ is greater than 1.3, or even 1.5, or even 2 or even 3. Obviously, in such sets, at least one particle has a ratio of its large diameter to its small diameter which is respectively greater than 1.3, 1.5, 2, 3. Furthermore, the morphology of the component particles is substantially retained during the polymerization. The polymer particles may thus substantially have an axis of revolution containing their large diameter if the component particles used to produce them substantially have an axis of revolution containing their large diameter.

72. The olefins which may be used for the polymerization are, for example, olefins containing from two to twenty carbon atoms and, in particular, the alpha-olefins of this group. Olefins which may be mentioned are ethylene, propylene, 1-butene, 4-methyl-1-pentene, 1-octene, 1-hexene, 3-methyl-1-pentene, 3-methyl-1-butene, 1-decene and 1-tetradecene, or mixtures thereof. The term polymerization which is used in the present application thus covers copolymerization reactions, and the term polymer covers copolymers.

73. Among the alpha-olefin mixtures, a mixture of ethylene and at least one alpha-olefin containing from three to eight carbon atoms is preferred, the percentage of ethylene in the mixture generally being greater than 90% by weight.

74. The polymers obtained generally have a weight-average molecular mass of between 5000 and 400,000.

75. A bulk polymerization process consists in performing a polymerization in at least one of the olefins to be polymerized maintained in the liquid or supercritical state.

76. The processes of solution or suspension polymerization consist in performing a solution or suspension polymerization in an inert medium and, in particular, in an aliphatic hydrocarbon.

77. For a solution polymerization process, a hydrocarbon containing from eight to twelve carbon atoms or a mixture of these hydrocarbons may be used, for example. For a suspension polymerization process, n-heptane, n-hexane, isohexane, isopentane or isobutane may be used, for example.

78. The operating conditions for these bulk, solution, suspension or gas-phase polymerization processes are those which are usually proposed for similar cases using conventional catalytic systems of supported or unsupported Ziegler-Natta type.

79. For example, for a process of suspension or solution polymerization, the process may be performed at temperatures ranging up to 250° C. and pressures ranging from atmospheric pressure to 250 bar. In the case of a polymerization process in liquid propylene medium, the temperatures may range up to the critical temperature and the pressures may be between atmospheric pressure and the critical pressure. For a process of bulk polymerization leading to polyethylenes or to copolymers predominantly made of ethylene, the process may be performed at temperatures of between 130° C. and 350° C. and at pressures ranging from 200 to 3500 bar.

80. A process of gas-phase polymerization may be carried out using any reactor which allows a gas-phase polymerization and, in particular, in a stirred-bed and/or fluidized-bed reactor.

81. The conditions for carrying out the gas-phase polymerization, in particular the temperature, pressure, injection of the olefin or of the olefins into the stirred-bed and/or fluidized-bed reactor, and control of the polymerization temperature and pressure, are similar to those proposed in the prior art for the gas-phase polymerization of olefins. The process is generally performed at a temperature below the melting point Tm of the polymer or prepolymer to be synthesized, and more particularly at a temperature of between +20° C. and (Tm-5)° C., and at a pressure such that the olefin or the olefins are essentially in the vapour phase.

82. A co-catalyst capable of activating the titanium of the catalytic component according to the invention must be present during the polymerization. This co-catalyst may be any co-catalyst for a catalytic component of Ziegler-Natta type. In particular, this co-catalyst may be an organoaluminium derivative.

83. This organoaluminium derivative may be a derivative of formula R¹R²R³Al in which R¹, R² and R³, which may be identical or different, each represent either a halogen atom or an alkyl group containing from 1 to 20 carbon atoms, at least one of R¹, R² and R³ representing an alkyl group. Examples of suitable compounds which may be mentioned are ethylaluminium dichloride or dibromide, isobutylaluminium dichloride or dibromide, diethylaluminium chloride or bromide, di-n-propylaluminium chloride or bromide and diisobutylaluminium chloride or bromide. In preference to the abovementioned compounds, a trialkylaluminium such as tri-n-hexylaluminium, triisobutylaluminium, trimethylaluminium or triethylaluminium is used.

84. The co-catalyst may also be an aluminoxane. This aluminoxane may be linear, of formula

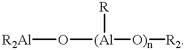

85. or cyclic, of formula

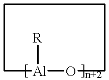

86. R representing an alkyl radical comprising from one to six carbon atoms, and n being an integer ranging from 2 to 40, preferably from 10 to 20. The aluminoxane may contain groups R of different nature. Preferably, the groups R all represent methyl groups. Moreover, the term co-catalyst is also understood to refer to mixtures of the abovementioned compounds.

87. The amounts of cocatalyst used during the polymerization must be sufficient to activate the titanium. Generally, an amount thereof is introduced such that the atomic ratio of the aluminium supplied by the co-catalyst to the titanium which it is desired to activate ranges from 0.5 to 10,000 and preferably from 1 to 1000.

88. The processes of solution, suspension, bulk or gas-phase polymerization way involve a chain-transfer agent, so as to control the melt index of the polymer to be produced. A chain transfer agent which may be used is hydrogen, this being introduced in an amount which may range up to 90% and preferably being between 0.01 and 60 mol % of the entire olefin and hydrogen supplied into the reactor.

89. An external electron donor may be present in the polymerization medium, in particular when an olefin having at least three carbon atoms must be polymerized or copolymerized. This external electron donor may be a silane of formula SiR¹R²R³ R⁴ in which at least one of the groups attached to the silicon is an alkoxide group of formula (—OR⁵) in which R⁵ represents a saturated linear hydrocarbon group containing 1 to 4 carbon atoms, and preferably 1 or 2 carbon atoms, it being possible for the other groups attached to the silicon to be hydrocarbon groups preferably containing 1 to 8 carbon atoms. This external electron donor may be a diether described in patent application EP 0,361,493.

90. In the examples which follow, the characteristics of the polymers were determined by the following techniques:

91. the SPAN: is equal to the ratio (D90-D10)/D50 in which D90, D10 and D50 represent the diameter below which 90%, 10% and 30% by weight of the particles are found respectively. For the support particles and component particles, the D90, D10 and D50 are measured using a Malvern C 2600 laser diffraction granulometer. For the polymer particles, the D90, D10 and D50 are measured by screening.

92. the morphology: is determined by observation under a scanning electron microscope for the seed particles, support particles and component particles, and by observation under an optical microscope for the polymer particles.

93. (Ds/ds)ₘ, (Dg/dg)ₘ, (Dc/dc)ₘ and (Dp/dp)ₘ were determined by calculating the respective averages of Ds/ds, Dg/dg, Dc/dc and Dp/dp on 70 particles observed either under a scanning electron microscope for the seed particles, support particles and component particles, or under an optical microscope for the polymer particles.

94. Flowability: ASTM standard D 1895

95. MI₂: ASTM standard D 1238-E

96. MI₅: ASTM standard D 1238-P

97. MI₂₁: ASTM standard D 1238-F

### EXAMPLE 1

98. a) Seed preparation

99. The following are introduced into a 5-liter reactor fitted with a paddle stirrer, a jacket-regulated temperature control system and a filtering plate at its lower part:

100. 300 g of commercial magnesium chloride containing 0.3% by weight of water, consisting of particles whose average diameter is about 2 mm,

101. 3000 g of tetrahydrofuran (THF)

102. 48 g of durene.

103. The stirring is brought to 150 revolutions per minute and the temperature is brought to 65° C.

104. After 12 hours, the solid is recovered by filtration, it is washed with 4000 ml of hexane and is then dried at 70° C. for 3 hours while flushing with nitrogen. 528 g of a pulverulent white solid essentially consisting of an MgCl₂·1.5 THF complex are finally recovered. This solid consists of particles having, under a scanning electron microscope, the form of 6- or 8-faced polyhedra. Table 1 collates the particle size characteristics (D50 and SPAN) of this solid, which is used subsequently as seed. By the test of ASTM standard D 1895, it is observed that these seeds do not flow. These seeds have an average ratio (Dg/dg)ₘ of 3.6.

105. These seeds have the appearance of polyhedra substantially possessing two planes of symmetry which are substantially perpendicular to each other. Furthermore, they are in the form of substantially regular six- or eight-faced polyhedra whose symmetrically opposite paired faces are substantially parallel and whose two elongated large faces forming the top face and the bottom face of a polyhedron, such that in each the largest diagonal (D) is greater than the smallest distance (d) separating two opposite sides, are substantially perpendicularly surrounded by the other substantially rectangular faces forming the sides of the said polyhedron, the length of the smallest side (e) of each of the said substantially rectangular faces being shorter than the smallest distance (d) separating the two opposite sides of the large elongated faces.

106. b) Preparation of a support

107. The following are introduced, under a nitrogen atmosphere and at room temperature, into a 2-liter glass reactor of Büchi autoclave type fitted with a stirring system and a temperature control system:

108. 25 g of the seeds prepared in a),

109. 500 ml of hexane,

110. 0.55 mol of n-butylethylmagnesium in the form of a solution at a concentration of 20% by weight in heptane. This solution contains about 0.1% by weight of traces of aluminium in the form of triethylaluminium.

111. While stirring at 600 revolutions per minute, the temperature of the reactor is brought to 80° C. over 30 minutes. 3.17 mol of tert-butyl chloride are then introduced using a pump, over 3 hours, after which the stirring and temperature conditions are maintained for one hour. The solid is then filtered off, washed three times with 500 ml of hexane each time, and then dried at 70° C. for 4 hours while flushing with nitrogen. 79 g of a support in the form of a pulverulent solid whose characteristics are given in Table 1 are finally recovered. By the test of ASTM standard D 1895, it is observed that the flowability of the support is 75 seconds.

112. This support consists of particles substantially possessing an axis of revolution containing their large diameter. These particles are seen to be substantially free of rough edges when they are observed at a magnification of 200 under a scanning electron microscope.

### EXAMPLE 2

113. The process is performed as in Example 1, except that the n-butylethylmagnesium is replaced by 0.55 mol of dibutylmagnesium in the form of a solution at a concentration of 25% by weight in hexane.

114. 98 g of a support in the form of a pulverulent solid whose characteristics are given in Table 1 are finally recovered. This support consists of particles substantially possessing an axis of revolution containing their large diameter. These particles are seen to be substantially free of rough edges when they are observed at a magnification of 200 under a scanning electron microscope.

### EXAMPLE 3

115. The process is performed as in Example 1, except that before introduction of the chlorinating agent, 0.013 mol of tri-n-hexylaluminium is added.

116. 88 g of a support in the form of a pulverulent solid whose characteristics are given in Table 1 are finally recovered. This support consists of particles substantially possessing an axis of revolution containing their large diameter. These particles are seen to be substantially free of rough edges when they are observed at a magnification of 200 under a scanning electron microscope.

### EXAMPLE 4

117. The process is performed as in Example 3, except that the tri-n-hexylaluminium is replaced by 0.013 mol of tetraisobutylaluminoxane. 80 g of a support in the form of a pulverulent solid whose characteristics are given in Table 1 are finally recovered. This support consists of particles substantially possessing an axis of revolution containing their large diameter. These particles are seen to be substantially free of rough edges when they are observed at a magnification of 200 under a scanning electron microscope.

### EXAMPLE 5

118. The process is performed as in Example 4, except that the seeds of MgCl₂·1.5THF are replaced by 12.5 g of seeds of MgCl₂·0.4THF complex, this complex having been obtained by heat treatment at 70° C. while flushing with nitrogen, at atmospheric pressure for 4 hours, of particles of MgCl₂·1.5THF. 72 g of a support in the form of a pulverulent solid whose characteristics are given in Table 1 are finally recovered.

### EXAMPLE 6

119. The process is performed as in Example 3, except that the tri-n-hexylaluminium is replaced by 0.013 mol of diethyl(methylethylsilanolato)aluminium of formula (C₂H₅)₂Al—O—SiH(CH₃) (C₂H₅), marketed under the brand name siloxal H-1 by the company Schering. 90 g of a support in the form of a pulverulent solid whose characteristics are given in Table 1 are finally recovered.

### EXAMPLE 7

120. The process is performed as in Example 4, except that the tert-butyl chloride is replaced by 0.818 mol of SiCl₄ in the form of a solution at a concentration of 20% by volume in hexane.

121. 70 g of support in the form of a pulverulent solid whose characteristics are given in Table 1 are finally recovered.

### EXAMPLE 8

122. a) Seed preparation

123. 50 g of α-MgCl₂ in the form of a powder with a diameter of less than 3 mm are introduced into a 430 ml ball mill flushed with nitrogen, containing 25 g of stainless steel balls 14 mm in diameter, 44 g of stainless steel balls 11 mm in diameter and 16 g of stainless steel balls 7 mm in diameter. The powder is ground at room temperature by subjecting the system to a vibrating vertical motion of amplitude 6 cm and of frequency 10 Hz for 12 hours. An MgCl₂ powder of δ form whose characteristics are given in Table 1 is thus recovered.

124. b) Preparation of a support

125. The process is performed as in Example 7, except that the MgCl₂·1.5THF seeds are replaced by 123 millimol of δ-MgCl₂ prepared in a). 37 g of a support in the form of a powder whose characteristics are given in Table 1 are finally recovered.

### EXAMPLE 9

126. a) Synthesis of a solid catalytic component

127. After flushing with nitrogen, 15 g of support obtained according to Example 1 are introduced into a 500 cm³ glass reactor equipped with a jacket-regulated temperature control and a mechanical paddle stirrer, followed by 49 cm³ of TiCl₄. The contents of the reactor are then heated for 2 hours at 80° C. while stirring at 200 revolutions per minute, and are then filtered and washed three times with, each time, a mixture of 10% by volume of TiCl₄ and 90% by volume of toluene, for 15 min. After filtration, the solid is dried for one hour at 80° C. while flushing with nitrogen. 10.5 g of a solid catalytic component in the form of a powder with a D50 of 28 μm and a SPAN of 1.01 are finally recovered. This component contains 1.5% by weight of THF and 3% by weight of titanium. It is composed of particles substantially possessing an axis of revolution containing their large diameter. These particles are seen to be substantially free of rough edges when they are observed at a magnification of 200 under a scanning electron microscope. They have a (Dc/dc)ₘ of 1.6.

128. b) Suspension polymerization of ethylene

129. 1 liter of hexane, then 6 millimol of triisobutylaluminium and then 20 mg of the catalytic component prepared in a) are introduced, at 40° C. and under nitrogen, into a 2-liter metal reactor fitted with a jacket-regulated temperature control and a stirring system.

130. 1 bar of partial pressure of nitrogen is introduced into the reactor, which is then brought to 85° C. The total pressure is adjusted with nitrogen to 3 bar absolute. 4 bar partial pressure of hydrogen and then 6 bar partial pressure of ethylene are subsequently added.

131. The total pressure is maintained at 13 bar absolute by addition of ethylene for 2 hours at 85° C., the stirring being 400 revolutions per minute. At the end of this period, the system is depressurized to atmospheric pressure and cooled to room temperature, and the polymer is recovered. The production efficiency of the polymerization was 15,300 g per g of solid catalytic component. The polymer has the following characteristics: D50=663 μm, SPAN=1.14, RMI=3.21, MFR=30.36 and MI₂=5.60. The polymer particles have a (Dp/dp)ₘ of 1.55. They are seen to be substantially free of rough edges when they are observed at a magnification of 20 under an optical microscope.

### EXAMPLE 10

132. a) Synthesis in suspension of a prepolymer

133. 0.8 liter of hexane, then 3.2 millimol of trihexylaluminium (THA), then 1 g of the solid catalytic component prepared in Example 9 and then 1.5 bar of hydrogen are introduced, under nitrogen and with stirring at 250 revolutions per minute at 40° C., into a dry 1-liter reactor. After homogenization for 5 minutes, ethylene is introduced at a flow rate of 10 Nl/h for 30 minutes and then at a flow rate of 45 Nl/h for 2 hours. The introduction of ethylene is then stopped, the reactor is depressurized to atmospheric pressure and the interior of the reactor is flushed with nitrogen while stirring at 50 revolutions per minute. The temperature is then brought to 60° C. and the hexane is removed by flushing with nitrogen.

134. After returning to room temperature, 98.5 grams of prepolymer containing 850 ppm of aluminium are finally collected. The degree of prepolymerization was 98.5 g of prepolymer per gram of solid catalytic component. This prepolymer is stored under nitrogen.

135. b) Gas-phase synthesis of a polymer

136. After flushing with nitrogen, the following are introduced, at 85° C., into an 8.2-liter reactor equipped with a jacket-regulated temperature control and a stirring system, stirring at 400 revolutions per minute:

137. 100 g of polyethylene originating from an identical test, then

138. 0.87 millimol of trihexylaluminium.

139. The reactor is then placed under vacuum (residual absolute pressure: 2 Pa), followed by injection of:

140. 3.75 bar of partial pressure of hydrogen,

141. 8 bar of partial pressure of ethylene.

142. 10 g of the prepolymer prepared in a) are then introduced by blowing with nitrogen until the total pressure inside the reactor reaches 21 bar absolute. The pressure is maintained at this value by addition of ethylene for 2 hours and the reactor is then depressurized and cooled. The polyethylene is finally collected. The production efficiency was 10,047 g of polyethylene per gram of solid catalytic component. The polymer obtained has the following characteristics:

143. Dp50=808 μm

144. Apparent density (non-packed): 0.417 g/cm³

145. Flowability: 20 seconds

146. MI₂=1.89

147. RMI=MI₅/MI₂=3.36

148. MFR=MI₂₁/MI₂=38.7

149. The polyethylene powder has a morphology which is homothetic to that of the support and has a (Dp/dp) of 1.6. It consists of particles substantially possessing an axis of revolution containing their large diameter. These particles are seen to be substantially free of rough edges when they are observed at a magnification of 20 under an optical microscope.

### EXAMPLE 11

150. a) Preparation of a support

151. The process is performed as in Example 1, except that, for the preparation of the support, 0.1 mol of n-butylethylmagnesium is introduced instead of 0.55 mol, and the tert-butylchloride is replaced by 0.45 mol of SiCl₄.

152. Support particles substantially having an axis of revolution containing their large diameter are thus obtained. Other characteristics of this support are indicated in Table 1. The average ratio (Ds/ds)ₘ is 3.2.

153. b) Preparation of a solid catalytic component

154. The support prepared in a) is treated as for the support in Example 9. A solid catalytic component in the form of a powder having a D50 of 37 μm and a SPAN of 1.7 is thus obtained. The average ratio (Dc/dc)ₘ is 3.2.

155. c) Preparation of a prepolymer

156. 0.8 liter of hexane, then 13.8 millimol of trihexylaluminium, then 1 g of the solid catalytic component prepared in b) and then 1.5 bar of hydrogen are introduced at 40° C., under nitrogen and with stirring at 250 revolutions per minute, into a dry one-liter reactor. After homogenization for 5 minutes, ethylene is introduced at a controlled flow rate of 95 Nl for two hours. The introduction of ethylene is then stopped, the reactor is depressurized to atmospheric pressure and the interior of the reactor is flushed with nitrogen while stirring at 50 revolutions per minute. The temperature is brought to 60° C. and the hexane is removed by flushing with nitrogen.

157. After cooling to room temperature, 97.8 grams of prepolymer containing 3040 ppm by weight of aluminium are finally collected. The degree of prepolymerization was 97.8 grams of prepolymer per gram of solid catalytic component.

158. d) Preparation of a polyethylene by gas-phase polymerization

159. After flushing with nitrogen, 100 g of polyethylene originating from an identical test are introduced at 90° C. into an 8.2-liter reactor equipped with a jacket-regulated temperature control and a stirring system, stirring at 400 revolutions per minute. The reactor is placed under vacuum (residual pressure of nitrogen: 2 Pa), followed by injection of 6 bar of partial pressure of hydrogen and then 8 bar of partial pressure of ethylene. 10 grams of prepolymer prepared in c) are subsequently introduced by blowing with nitrogen until the absolute pressure inside the reactor reaches 21 bar. This final pressure is kept constant for two hours by addition of ethylene, after which the reactor is cooled and depressurized.

160. 479 grams of polyethylene (initial charge deducted) are finally collected. The production efficiency was 4700 grams of polyethylene per gram of solid catalytic component. The polymer obtained has the following characteristics:

161. D50=411 μm

162. SPAN=1.06

163. Flowability by the test of ASTM standard D 1895: 30 seconds

164. MI₂=10.3

165. RMI=MI₅/MI₂=2.63

166. This polymer powder has a morphology which is substantially homothetic to that of the support prepared in a). Its (Dp/dp) is 3.3.

### EXAMPLE 12

167. a) Preparation of a support

168. The following are introduced at room temperature into a two-liter reactor fitted with a jacket-regulated temperature control and a stirring system:

169. 25 g of the seeds prepared as in Example 1a), then

170. 500 ml of hexane, then

171. 4 ml of THF and then

172. 0.1 mol of n-butylethylmagnesium in the form of a solution at a concentration of 20% by weight in heptane.

173. The reactor is placed under a slight pressure of nitrogen, the stirring is set at 400 revolutions per minute and the temperature is raised to 75° C. A solution of 0.15 mol of SiCl₄ in 62.8 ml of hexane is then introduced at a flow rate of 200 ml/hour, after which the suspension is maintained at 80° C. for one hour while stirring at 400 revolutions per minute. The solid obtained is filtered off and washed with 500 ml of hexane for 30 minutes. This operation of filtration and washing with hexane is repeated twice more.

174. The solid is then dried at 70° C. for four hours while flushing with nitrogen. 32 grams of support having a SPAN of 1.38 are finally recovered. This support substantially has the composition MgCl₂·1THF. The (Ds/ds) is 3.22.

175. These particles substantially have an axis of revolution containing their large diameter. They are seen to be free of rough edges under an electron microscope (magnification: 200).

176. b) Preparation of a catalytic component

177. After flushing with nitrogen, 10 g of the support prepared in a) and then 32.5 ml of toluene and 97.5 ml of pure TiCl₄ are introduced at 50° C. into a 300 ml reactor fitted with a temperature control and a stirring system. The temperature is brought to 90° C. and 1.46 ml of dibutyl phthalate are then introduced. The mixture is left stirring at this temperature for two hours. After filtration, the following treatment is carried out: 6.5 ml of TiCl₄ and 123.5 ml of toluene are introduced, the temperature is maintained at 100° C. for one hour and the mixture is filtered. This treatment is repeated a further four times. The solid is subsequently washed three times, each time with 100 ml of hexane at 60° C. for 10 minutes. The solid is then dried at 60° C. for two hours while flushing with nitrogen. The catalytic component thus obtained contains 2% by weight of titanium and 11.8% of dibutyl phthalate. It has a SPAN of 1.35 and a ratio (Dc/dc)ₘ of 3.1.

178. c) Synthesis of polypropylene

179. The following are introduced at 30° C., in sequence, into a 3.5-liter stainless steel reactor fitted with magnetic stirring and a jacket-regulated temperature control: 1.2 Nl of hydrogen, 2.4 liters of liquid propylene, 24 millimol of triethylaluminium and 2.4 millimol of cyclohexylmethyldimethoxysilane (CHMDMS). After stirring for 10 minutes, 20 mg of the catalytic component prepared in b) are introduced. The temperature is raised to 70° C. and maintained at this value for one hour. The reactor is then cooled and the pressure lowered to atmospheric pressure. The production efficiency was 28,200 grams of polymer per gram of catalytic component. The isotactic index of the polypropylene powder, measured by extraction with heptane of the amorphous polymer using a Kumagawa machine, is 97.4% by weight. The melt index measured according to ASTM standard D 1238, method 2 is 3.1. The flowability of this powder is 23 seconds. The polypropylene particles have a morphology which is substantially homothetic to those of the support. They substantially have an axis of revolution containing their large diameter and are seen to be free of rough edges under an optical microscope (magnification: 20). The (Dp/dp)ₘ is 3.1.

### EXAMPLE 13 (comparative)

180. The process is performed as in Example 1, except that no seeds are prepared and none are thus introduced for the manufacture of support.

181. A powder having the following characteristics is obtained:

182. D50=56.45 μm,

183. SPAN=5.82.

184. The powder has no controlled morphology, and has no axis of symmetry.

TABLE 1

| | | | Composition | | | | | | | Compsotion (% by | | | | | |
|---|---|---|---|---|---|---|---|---|---|---|---|---|---|---|---|
| Ex. | | D50 | | | | Nature of | | | D50 | | | | | | |
| No. | SPAN | (μM) | Mg | Cl | THF | the seeds | (Dg/dg)ₘ | SPAN | (μm) | Mg | Cl | THF | Al | Si | (Ds/ds)ₘ |
| 1 | 1.9 | 29 | 12 | 35 | 53 | MgCl₂-1.5 THF | 3.6 | 1.03 | 37 | 15 | 45 | 10 | 0.2 | — | 1.6 |
| 2 | 1.9 | 29 | 12 | 35 | 53 | MgCl₂-1.5 THF | 3.6 | 1.8 | 24.1 | 15 | 41 | 9.6 | — | — | 1.7 |
| 3 | 1.9 | 29 | 12 | 35 | 53 | MgCl₂-1.5 THF | 3.6 | 1.8 | 32 | 18 | 49 | 5.4 | 1 | — | 2 |
| 4 | 1.9 | 29 | 12 | 35 | 53 | MgCl₂-1.5 THF | 3.6 | 1.25 | 24.4 | 17 | 53 | 9.7 | 1 | — | 1.8 |
| 5 | 1.7 | 19.3 | | | | MgCl₂-0.4 THF | 3.6 | 1.42 | 58.3 | 17.6 | 54.3 | 2 | 1 | — | 1.7 |
| 6 | 1.9 | 29 | 12 | 35 | 53 | MgCl₂-1.5 THF | 3.6 | 1.77 | 56.5 | 16 | 49 | 7.3 | 1 | 1 | 2.1 |
| 7 | 1.9 | 29 | 12 | 35 | 53 | MgCl₂-1.5 THF | 3.6 | 1.2 | 40 | 16 | 50 | 8.3 | 1 | 0.2 | 1.8 |
| 8 | 5.6 | 23 | 25 | 73 | — | δ-MgCl₂ | | 0.64 | 63 | 20 | 58.4 | | 1 | 0.2 | 1.4 |
| 11 | 1.9 | 29 | 12 | 35 | 53 | MgCl₂-1.5 THF | 3.2 | 1.38 | 31 | 14 | 42 | 43 | 0.2 | 0.2 | 3.2 |

185. Although the invention has been described in conjunction with specific embodiments, it is evident that many alternatives and variations will be apparent to those skilled in the art in light of the foregoing description. Accordingly, the invention is intended to embrace all of the alternatives and variations that fall within the spirit and scope of the appended claims. The above references are hereby incorporated by reference.

1. Process for the manufacture of particles comprising magnesium chloride, this process comprising a step of placing in contact between:
seeds,
an organomagnesium derivative,
an chlorinating agent for the organomagnesium derivative.

2. Process according to claim 1, characterized in that the seeds contain less than 90% by weight of carbon.

3. Process according to claim 1 or 2, characterized in that the seeds contain more than 30% by weight of magnesium chloride.

4. Process according to one of claims 1 to 3, characterized in that the seeds contain magnesium chloride in a form which is capable of fixing titanium chloride.

5. Process according to one of claims 1 to 4, characterized in that the seeds comprise magnesium chloride in β or δ form.

6. Process according to one of claims 1 to 5, characterized in that the seeds comprise a complex of formula (MgCl₂·n solvent).

7. Process according to claim 6, characterized in that the solvent is tetrahydrofuran.

8. Process according to claim 6 or 7, characterized in that n ranges from 1 to 2.

9. Process according to one of claims 1 to 8, characterized in that the average diameter of the seeds ranges from 1 to 100 μm.

10. Process according to one of claims 1 to 9, characterized in that the SPAN of the seeds ranges from 0.4 to 6.

11. Process according to one of claims 1 to 10, characterized in that the SPAN of the seeds is less than 3.

12. Process according to one of claims 1 to 11, characterized in that the seeds have an average ratio of their large diameter to their small diameter of greater than 1.4.

13. Process according to claim 12, characterized in that the seeds have an average ratio of their large diameter to their small diameter of greater than 1.6.

14. Process according to claim 13, characterized in that the seeds have an average ratio of their large diameter to their small diameter of greater than 2.1.

15. Process according to claim 13, characterized in that the seeds have an average ratio of their large diameter to their small diameter of greater than 3.1.

16. Process according to one of claims 1 to 14, characterized in that the seeds are in the form of polyhedra substantially possessing two planes of symmetry which are substantially perpendicular to each other.

17. Process according to one of claims 1 to 16, characterized in that the seeds are in the form of substantially regular six- or eight-faced polyhedra, the symmetrically opposite paired faces of which are substantially parallel and two large elongated faces of which forming the top face and the bottom face of a polyhedron, such that in each the largest diagonal (D) is greater than the smallest distance (d) separating two opposite sides, are substantially perpendicularly surrounded by the other substantially rectangular faces forming the sides of the said polyhedron, the length of the shortest side (e) of each of the said substantially rectangular faces being shorter than the shortest distance (d) separating the two opposite sides of the large elongated faces.

18. Process according to one of claims 1 to 17, characterized in that the organomagnesium derivative is of formula R¹MgR² or (R¹MgR²)·×(Al(R³)₃) in which R¹ and R², which may be identical or different, represent alkyl radicals containing from 2 to 12 carbon atoms and R³ represents an alkyl radical containing from 1 to 12 carbon atoms.

19. Process according to one of claims 1 to 18, characterized in that the medium of placing in contact comprises an organoaluminium derivative.

20. Process according to claim 19, characterized in that the organoaluminium derivative is an aluminoxane or an aluminosiloxane.

21. Process according to one of claims 1 to 20, characterized in that the chlorinating agent is capable of reacting with the organomagnesium derivative so as to form Mg—Cl bonds.

22. Process according to claim 21, characterized in that the chlorinating agent is tert-butyl chloride.

23. Process according to claim 21, characterized in that the chlorinating agent is silicon tetrachloride.

24. Process according to one of claims 1 to 23, characterized in that the amounts of chlorinating agent and of organomagnesium derivative are such that the Cl/Mg molar ratio ranges from 1 to 10.

25. Process according to one of claims 1 to 24, characterized in that the medium of placing in contact comprises an inert solvent.

26. Process according to one of claims 1 to 25, characterized in that the placing in contact is performed between 10 and 140° C. and preferably between 40 and 110° C.

27. Process according to one of claims 1 to 26, characterized in that, for the placing in contact, the seeds, the optional inert solvent and the organomagnesium derivative are first placed together, followed by addition of the chlorinating agent to the above constituents.

28. Process according to one of claims 1 to 27, characterized in that the medium of placing in contact contains no ether oxide of formula R^{a}—O—R^{b} in which R^{a} and R^{b} are alkyl radicals.

29. Process according to one of claims 1 to 28, characterized in that the medium of placing in contact contains no cyclic ether.

30. Process according to one of claims 1 to 29, characterized in that the medium of placing in contact comprises an electron donor.

31. Particle comprising MgCl₂ and substantially possessing an axis of revolution containing its large diameter, characterized in that the ratio of its large diameter to its small diameter is greater than 1.3.

32. Particle according to claim 31, characterized in that the ratio of its large diameter to its small diameter is greater than 1.5.

33. Particle according to claim 32, characterized in that the ratio of its large diameter to its small diameter is greater than 2.

34. Particle according to claim 33, characterized in that the ratio of its large diameter to its small diameter is greater than 3.

35. Set of particles comprising MgCl₂ and substantially possessing an axis of revolution containing their large diameter, characterized in that the average ratio of the large diameter to the small diameter of the particles is greater than 1.3.

36. Set of particles according to claim 35, characterized in that the average ratio of the large diameter to the small diameter of the particles is greater than 1.5.

37. Set of particles according to claim 36, characterized in that the average ratio of the large diameter to the small diameter of the particles is greater than 2.

38. Set of particles according to claim 37, characterized in that the average ratio of the large diameter to the small diameter of the particles is greater than 3.

39. Particles according to one of claims 31 to 38, characterized in that they are capable of fixing titanium chloride.

40. Particles according to one of claims 31 to 39, characterized in that they comprise a transition metal compound and in that they are capable of polymerizing olefins.

41. Particles according to one of claims 31 to 40, characterized in that they are substantially free of rough edges.

42. Particles according to one of claims 31 to 41, characterized in that they comprise titanium, chlorine, optionally an aluminium compound, and optionally an electron donor or acceptor.

43. Polyolefin particle substantially possessing an axis of revolution containing its large diameter, characterized in that the ratio of its large diameter to its small diameter is greater than 1.3.

44. Particle according to claim 43, characterized in that the ratio of its large diameter to its small diameter is greater than 1.5.

45. Particle according to claim 44, characterized in that the ratio of its large diameter to its small diameter is greater than 2.

46. Particle according to claim 45, characterized in that the ratio of its large diameter to its small diameter is greater than 3.

47. Set of polyolefin particles substantially possessing an axis of revolution containing their large diameter, characterized in that the average ratio of the large diameter to the small diameter of the particles is greater than 1.3.

48. Set according to claim 47, characterized in that the average ratio of the large diameter to the small diameter of the particles is greater than 1.5.

49. Set according to claim 48, characterized in that the average ratio of the large diameter to the small diameter of the particles is greater than 2.

50. Set according to claim 49, characterized in that the average ratio of the large diameter to the small diameter of the particles is greater than 3.

51. Particles according to one of claims 43 to 50, characterized in that they are substantially free of rough edges.

52. Particles according to one of claims 43 to 51, characterized in that they are made of polyethylene.

53. Particles according to one of claims 43 to 51, characterized in that they are made of polypropylene.
